(19) United States
(12) Patent Application Publication
(10) Pub. No.: US 2002/0172584 A1
(43) Pub. Date: Nov. 21, 2002

(54) Pickup tailgate loading ramp

(76) Inventor: George M. Huggins, Blanchard, OK (US)

Correspondence Address: JAMES T. ROBINSON, EXCLUSIVITY-LAW, INC., 222 EAST MAIN STREET, NORMAN, OK, 73069-1303, US

(21) Appl. No.: 09/750,498

(22) Filed: Dec. 29, 2000

(51) Int. Cl. B60P 1/00

(52) U.S. Cl. 414/537; 296/61; 14/71.1

(57) ABSTRACT

A pickup truck tailgate and loading ramp is formed by a main frame dimensioned to be hingedly received by a given pickup bed. Two pairs of hingedly interconnected frames are rigidly secured to the top rail of the tailgate section and form a pair of ramp tracks when in tailgate lowered position. When not in use the track forming frames are disposed rearwardly of the closed tailgate section.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This present invention relates to loading ramps and more particularly combination pickup truck tailgate and loading ramp.

1. Field of the Invention

2. Description of the Prior Art

When loading articles of considerable mass into a pickup bed it has been common practice to lower the pickup tailgate and provide a temporary ramp, particularly if the article to be loaded is equipped with wheels such as riding lawn mowers or golf carts, in which the temporary ramp consists of lengths of lumber, such as 2 by 8 or 2 by 12, extending from the rearward edge of the pickup tailgate to the surface of the earth. Additionally, ramp ends or ramp feet which are attached to the respective ends of such temporary lumber ramps are commercially available to form a smooth transition from the surface of the earth and the upper end portion of the temporary ramp and the horizontal surface of the tailgate.

This invention is distinctive over such ramps for pickup trucks by providing one end of the ramp of this invention to serve as a pickup tailgate and including pairs of rigidly connected track forming frames extending from the tailgate position to the surface of the earth in which these frames are hinged intermediate their ends and provided with a gravity positioned support.

### BRIEF SUMMARY OF THE INVENTION

A rectangular frame having overall dimensions substantially equal with the perimeter dimensions of the standard tailgate for the pickup truck to be equipped with a loading ramp is provided with hinge and latch mounting members securing the rectangular main frame to the pickup bed for vertical movement about a horizontal axis in opening and closing the tailgate portion. Additionally two pairs of elongated rectangular frames cooperatively hinged together are rigidly connected at one end in laterally spaced relation to the top edge surface forming the rectangular main frame with the other ends of the pairs of hinged frames resting on the surface of the earth and supported at their hinged position by a gravity positioned U-shaped frame pivotally depending from the hinge position of the track forming frames. Each of the main frame and hinged rectangular frames are transversely provided with a plurality of equally spaced apart right angle cross members forming an open frame work for supporting the wheels of vehicles being moved up or down the ramp from the surface of the earth to the bed of the pickup or vice versa. When not in use as a ramp the main frame forms the tailgate of a pickup bed and the remaining portion of the ramp is disposed upright adjacent the vertical plane of the tailgate for ease in lowering the ramp to a loading or unloading position by simply lowering the tailgate and extending the hinged frames rearwardly to the surface of the earth.

The principal object of this invention is to provide a pickup loading ramp having a tailgate portion, which remains connected with the pickup at all times and is easily moved from a pickup bed closed position to a pickup bed ramp loading or unloading position for wheel equipped vehicles.

### BRIEF DESCRIPTION OF THE SEVERAL VIEWS OF THE DRAWINGS

FIG. 1 is a perspective view of the loading ramp in operative position on a pickup truck, the truck chassis being omitted for clarity;

FIG. 2 is a rearward elevational view of the loading ramp when folded to pickup tailgate closed position, of the pickup cab omitted for clarity;

FIG. 3 is a top plan view of the loading ramp, per se;

FIG. 4 is a fragmentary vertical cross sectional view, to a different scale, taken substantially along the line 4-4 of FIG. 3;

FIG. 5 is a perspective view of the loading ramp in operative position when viewed from one side;

FIG. 6 is a fragmentary side elevational view of the loading ramp when folded to tailgate closed position;

FIG. 7 is a top plan view of a modified ramp for loading and unloading three wheel vehicles;

FIG. 8 is a top plan view of loading ramp track sections forming the alternative embodiment of FIG. 7; and,

FIG. 9 is an elevational view of the hinged track support.

### DETAILED DESCRIPTION OF THE INVENTION

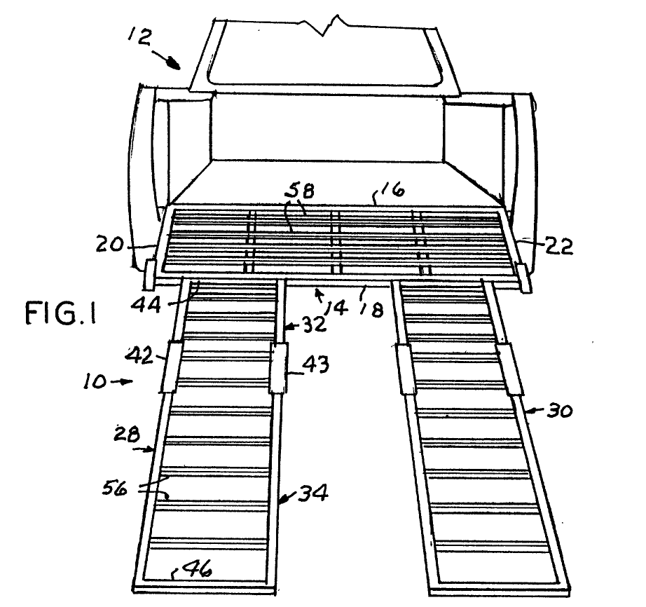

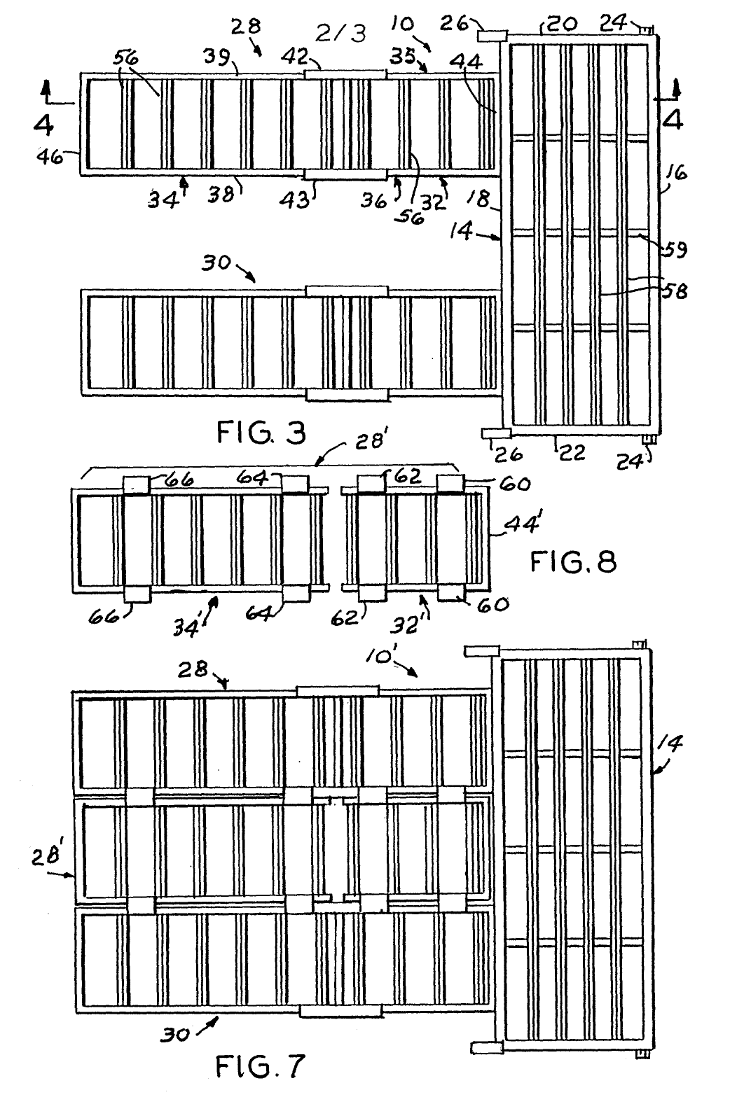

Referring first to FIGS. 1 and 3, the reference numeral 10 indicates a generally rectangular frame in overall configuration lying in a common plane, forming a ramp, pivotally connected at one end with the tailgate position of a conventional pickup truck 12.

The ramp 10 includes a rectangular tailgate portion 14 having overall dimensions substantially equal with the overall dimensions of a tailgate of the pickup truck 10. The tailgate section 14 comprises a base rail 16 connected, in parallel relation, with a top rail 18 both formed from tubing material and interconnected by a pair of tubular end rails 20 and 22. A pair of hinge members 24 cooperating with the tailgate hinges, not shown, project outwardly from respective end portions of the base rail 16 at its juncture with the end rails 20 and 22, respectively. Respective end portions of the top rail support a pair of latches 26 for securing the tailgate 14 in closed position.

The ramp 10 further includes a pair of elongated ramp tracks 28 and 30 rigidly connected at one end in laterally spaced relation with the top rail 18 of the gate section 14. Since the ramp forming tracks 28 and 30 are identical, only the track 28 is described, in detail in the interest of brevity.

The track 28 comprises a pair of U-shaped frame members 32 and 34 having leg end portions 35-36 and 38-39 respectively disposed in confronting relation and pivotally connected with one flange of a pair of right angle hinge forming members 42 and 43 for vertical pivoting movement of the U-shape member 34 toward and away from the underside of the other U-shaped member 32, as viewed in FIG. 3. The bight portion 44 of the U-shaped member 32 is rigidly secured longitudinally to one end portion of the tailgate top rail 18 in spaced relation with respect to the other track 30. The bight portion 46 of the U-shaped member 34 is normally supported by the surface of the earth 47 (FIG. 5).

A track support member 50 (FIG. 9) comprising a U-shaped member having a tubular bight portion 51 and upstanding angular metal legs 52 and 54 pivotally connected with the hinge forming members 42 and 43 between the confronting ends of the legs of the U-shaped members 32 and 34. The track support 50 is normally vertically disposed, by gravity, and contacts the surface of the earth 47 below the respective track 28 and 30 when the loading ramp 10 is disposed in loading position (FIG. 5).

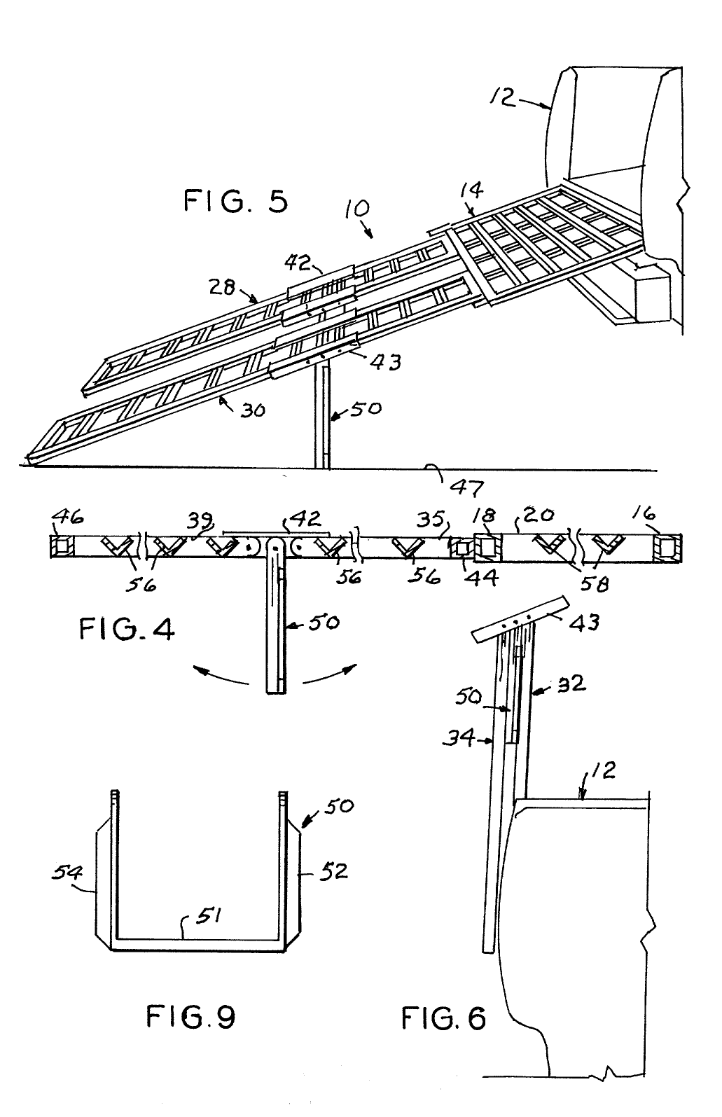

The track 28 further includes a plurality of transverse cross members 56 extending between the legs of the U-shaped members 32 and 34 in longitudinal equally spaced relation. Each of the cross members 56 comprise a length of rigid right angle metal disposed with the edges of the angular flanges directed upwardly as viewed in FIG. 4 for increased frictional resistance against the wheels of vehicles moving up or down the plane of the ramp during the loading or unloading movement. Similarly, the tailgate section 14 is provided with a plurality of longitudinally cross members 58 extending between the end rails 20 and 22 and are identical in transverse cross section with the track cross members 56. A plurality of brace members 59 extend between the tailgate bottom rail 16 and top rail 18 for rigidity.

### OPERATION

In operation of the embodiment 10, assuming the factory equipped tailgate of the truck 12 has been removed, the tailgate section hinge members 24 are cooperatively received by the hinge members of the tailgate, not shown, on the pickup truck bed. The latches 26 secure the tailgate section 14 when in closed position to the pickup bed side walls. When not in use the ramp track members 28 and 30 are disposed in the position illustrated by FIG. 6 with the U-shaped members 34 depending from the hinge members 42 and 43 and the track support members 50 interposed between the U-shaped frames 32 and 34.

When it is desired to utilize the track for loading and unloading a wheeled vehicle, not shown, the tailgate latches 26 are released and the ramp 10 is pivoted downwardly and rearwardly about the horizontal axis of the tailgate hinge members 24 until the bight portion 46 of the U-shaped member 34 rests on the surface of the earth 47 and gravity disposes the track support 50 in a vertical position (FIG. 5). Thereafter a wheeled vehicle, not shown, under its own power may be driven up or down the plane formed by the loading ramp 10.

An alternative embodiment 10′ is illustrated by FIG. 7 in the event it is desired to load a three wheel vehicle into the pickup bed. A temporary track 28′ (FIG. 8) is interposed between the tracks 28 and 30 to supply a track for the single front or rear wheel of a three wheel vehicle in negotiating the ramp 10′. The temporary track 28′ similarly comprises a U-shaped frame member 32′ and a companion U-shaped frame member 34′, each having their respective legs disposed in confronting relation. The bight portion 44′ of the U-shaped member 32′ is interposed between the tracks 28 and 30 adjacent the tailgate top rail 18. The U-shaped member 32′ is maintained in interposed relation between the tracks 28 and 30 by pairs of flanges 60 and 62 secured in transverse opposition to the legs of the U-shaped member 32′ and overlap the adjacent legs of the members 28 and 30. Similarly the other U-shaped member 34′ is provided with pairs of rigidly connected flanges 64 and 66 similarly overlapping the legs of the adjacent tracks 28 and 30 to complete the configuration of the alternative embodiment 10′.

Obviously the invention is susceptible to changes or alterations without defeating its practicability. Therefore, I do not wish to be confined to the preferred embodiment(s) shown in the drawing(s) and described herein.

I claim:

1. A pickup truck tailgate and loading ramp, comprising:
main frame means including a base rail and a top rail for occupying the position and function of a pickup tailgate; and,
elongated frame means connected at one end with said main frame means top rail for forming a loading ramp track when in tailgate lowered position.

2. The truck tailgate and loading ramp according to claim 1 in which said frame means comprises:
two pairs of longitudinally hingedly interconnected frames rigidly connected in laterally spaced relation with said main frame top rail; and,
a ramp track support hingedly depending from the hinged position of said pairs of frames.

3. The truck tailgate and loading ramp according to claim 2 and further including:
a plurality of cross members extending transversely of said main frame and said one frame in longitudinal spaced-apart relation.

4. The truck tailgate and loading ramp according to claim 1 in which said frame means comprises:
at least one pair of longitudinally hingedly interconnected frames; and,
a ramp track support hingedly depending from the hinged position of said one pair of frames.

5. The truck tailgate and loading ramp according to claim 4 and further including:
a plurality of cross members extending transversely of said main frame and said one frame in longitudinal spaced-apart relation.

6. A pickup truck tailgate and loading ramp, comprising:
main frame means including end rails connected with a base rail and a top rail for occupying the position and function of a pickup tailgate;
pairs of elongated U-shaped frame means having hingedly connected legs and rigidly connected at one end in laterally spaced relation with said main frame means top rail for forming loading ramp tracks when in tailgate lowered position; and,
a ramp track support hingedly depending from the hinged position of said pairs of frames.

7. The truck tailgate and loading ramp according to claim 6 and further including:
a plurality of cross members extending transversely of said main frame and said pairs of frames in longitudinal spaced-apart relation.
